(19) United States
(12) Patent Application Publication
(10) Pub. No.: US 2004/0237706 A1
(43) Pub. Date: Dec. 2, 2004

(54) Welded camshaft and method for production thereof and the required cams

(76) Inventor: Karl Merz, Reinach (CH)

Correspondence Address: Tarolli Sundheim Covell & Tummino, Suite 1111, 526 Superior Avenue, Cleveland, OH, 44114-1400, US

(21) Appl. No.: 10/480,572

(22) PCT Filed: Jun. 13, 2002
(86) PCT No.: PCT/CH02/00319

(30) Foreign Application Priority Data
Jun. 13, 2001 (CH) 1073/01

(51) Int. Cl. F16H 53/00

(52) U.S. Cl. 74/567; 29/888.1

(57) ABSTRACT

The invention relates to a finished camshaft (10) with several cams (1), fixed to a shaft (9), by means of at least one welded joint (11) each, whereby the shaft is made from a first low-carbon steel and the cams comprise a hardened or hardenable rocker running surface (2) made from a high-carbon steel (3) and are made from at least two different materials with a second low-carbon steel, which may be efficiently welded to the steel of the shaft, provided in at least one of the regions (4) affected by the welding.

### TECHNICAL FIELD

The present invention relates to a built-up camshaft with a plurality of cams fastened on a shaft in each case by means of at least one weld, the shaft consisting of a first low-carbon steel, and the cams having a hardened or hardenable rocker running surface consisting of a high-carbon steel.

The invention also relates to production methods for such a camshaft and to the cams required for this purpose.

### PRIOR ART

Built-up camshafts with cams fastened on a shaft by welding have already been described many times in the prior art. U.S. Pat. No. 4,983,797 A1 and DE 34 33 595 A1 also disclose the use of a laser for making the welded joint. The documents mentioned obviously assume that welding does not present any major problems, in any event they do not refer to such problems explicitly.

In practice, however, it has been shown that, because of the materials to be used for the cams, as a rule high-carbon hardenable steels, welding is not quite so simple and permanent joints satisfying the requirements in internal combustion engines cannot readily be produced. It was accordingly not possible for welded joints to gain acceptance up to now in the case of built-up camshafts. Use is still made of very costly camshafts produced from one piece by forging or those in which individual cams are fixed on a shaft by form fitting, thermally and/or using the internal high pressure method.

DE 3743816 C2 discloses a cam for a built-up camshaft, in which the cam tip has embedded into it a hard-metal insert which is soldered to the remaining cam material and which withstands more effectively the surface pressure which is higher in the region of the cam tip. No statement is made as regards the fastening of the cams on the shaft.

### PRESENTATION OF THE INVENTION

The object of the present invention is to specify how, in the case of a built-up camshaft of the type initially mentioned, a welded joint sufficient for the continuous loads in practice can be achieved cost-effectively.

With regard to the camshaft, this object is achieved, according to the invention, by means of the measures characterized in patent claim 1. The solution according to the invention accordingly lies in the use of cams which are composed of at least two different materials and for which a second low-carbon steel capable of being welded effectively to the steel of the shaft is used in each case in at least one region affected by the weld.

The different materials of the cams may be connected to one another by soldering, plating, form fitting, nonpositively, by form fitting and friction, adhesive bonding, riveting and/or welding, but, in particular, resistance pressure and/or friction welding. In the case of resistance pressure and/or friction welding, in particular, the formation of microcracks and/or macrocracks can be avoided under the pressure which is applied in this case.

According to a first preferred embodiment, the cams have a core which comprises the rocker running surface and consists of the high-carbon steel and which is arranged in the axial direction between at least two annular and/or ring-segment-shaped elements welded to the shaft and consisting of the second low-carbon steel.

Conversely, the cams could have a core welded to the shaft and consisting of a second low-carbon steel, said core being arranged in the axial direction between two annular elements comprising the rocker running surface and consisting of the high-carbon steel.

According to another embodiment, the cams could also have an at least two-shell construction and have an outer shell comprising the rocker running surface and consisting of the high-carbon steel and at least one inner shell welded to the shaft and consisting of the second low-carbon steel.

Finally, transitional forms between these variants are also possible.

Preferably, the part or parts of the cams consisting of the second low-carbon steel are welded to the shaft in a fully encircling manner. A high stability of the cams is thereby achieved.

In a particularly economic way, those parts of the cams which form or comprise the rocker running surfaces can be produced from bent profile strips, the profile strip or profile strips projecting in each case from the shaft, preferably in the region of the cam tip, in order to save weight and material. Mutually abutting ends of the profile strip or profile strips may in this case be welded to one another, in particular by resistance pressure welding. It would also be possible, however, for the mutually abutting ends to be connected to one another solely via that part or those parts of the cams which consist of the second low-carbon steel. It may be advantageous, particularly in this case, if the mutually abutting ends are designed to overlap one another in the circumferential direction.

According to a further embodiment, those parts of the cams which form or comprise the rocker running surfaces may also be formed in one piece and surround the shaft, flush, for example over the entire circumference.

Applying the weld in order to fasten the cams on the shaft can be made easier in that a foot ring is provided adjacently to the shaft in the part or parts consisting of the second low-carbon steel, in at least one of the regions affected by the weld, and the weld is executed through this foot ring.

The first low-carbon steel used for the shaft and/or the second low-carbon steel used for the cams should have a carbon content of lower than 0.5%. By contrast, the high-carbon steel used for the rocker running surface of the cams, in order to be effectively and sufficiently hardenable, may have a carbon content of more than 0.5%, but, in particular, of more than 0.75%.

With regard to the method, the abovementioned object is achieved, according to the invention, by means of at least one of the methods according to claims 15-19.

In the method according to claim 15, the rocker running surfaces of the cams, even before assembly, are hardened to their what may be referred to as activity hardness (for example, to 64 HR_{c}++) and, if appropriate, are additionally annealed. Thermal load on the entire camshaft, which could lead to shaft distortion, is thereby advantageously avoided.

On account of the low carbon content of the material of the cams consisting of the second low-carbon steel and of the low-carbon steel of the shaft, a hardness increase in the region of the weld seal or of what may be referred to as the heat influence zone when they are being welded together is avoided. As a result, there is also no widening of the assembly gap, this being associated with the occurrence of fine cracks. According to claim 16, welding can consequently be carried out at the ambient temperature of the parts to be welded to one another. A preheating of the shafts in order to avoid excessively high thermal stresses is unnecessary. There is also no need for subsequent heating of the assembled camshafts for the purpose of reducing too high a weld seam hardness, with the result that, finally, a variation in the hardness of the previously hardened rocker running surfaces of the cams is avoided. The welding of the cams can be carried out in the way described with reliable process control. The quality of the weld seam does not have to be checked constantly.

According to claim 17, welding for the fastening of the cams on the shaft takes place by laser.

Owing to the good weldablity of the material of the cams, consisting of the second low-carbon steel with the low-carbon steel of the shaft, welding for fastening the cams on the shaft may be carried out, according to the method of claim 18, at a welding speed of higher than 2 m/s, but, in particular of higher than 4 m/s. As a result, high manufacturing speeds can be achieved and the installations, which are costly when laser welding devices are used, can be utilized optimally.

According to claim 19, in the production of a camshaft according to the invention, the cams, before being welded to the shaft, are prefixed on the shaft in that their elements to be welded to the shaft and consisting of the second low-carbon steel are calked together with the shaft. This can be executed, for example, simply by tong pressure and makes it easier to carry out the subsequent welding in which the cams do not have to be retained additionally on the shaft and the shaft, together with the prefixed cams, can be rotated through under a fixed-welding beam.

According to claim 20, the subject to the invention is also the individual cams, such as may be gathered, in terms of their construction from the claims directed at the camshaft as a whole.

A general advantage of the invention is to be seen in that the cam material is virtually freely selectable, specifically irrespective of the welded joint technology between cams and shaft.

### BRIEF EXPLANATION OF THE FIGURES

The invention will be explained in more detail below with reference to exemplary embodiments, in conjunction with the drawing in which:

FIG. 1 shows, under a), a first embodiment of a cam according to the invention in an end view, and under b), the same cam in section (A-A);

FIG. 2 shows, under a), a longitudinal section through a longitudinal portion of a camshaft according to the invention with a cam according to FIG. 1 and under b), a cross section (B-B) through this camshaft;

FIG. 3 shows, in an enlargement of a detail from FIG. 2a), a special embodiment of a cam according to the invention with a welding foot;

FIG. 4 shows various forms of cores for cams according to the invention;

FIG. 5 shows a closed hollow cam in a front view under a) and in section (C-C) under b);

FIG. 6 shows under a)-f), further embodiments of cores for the cams according to the invention; and

FIG. 7 shows, under a)-g), further embodiments of cams according to the invention in each case in section and in illustrations of a detail.

### EMBODIMENTS OF THE INVENTION

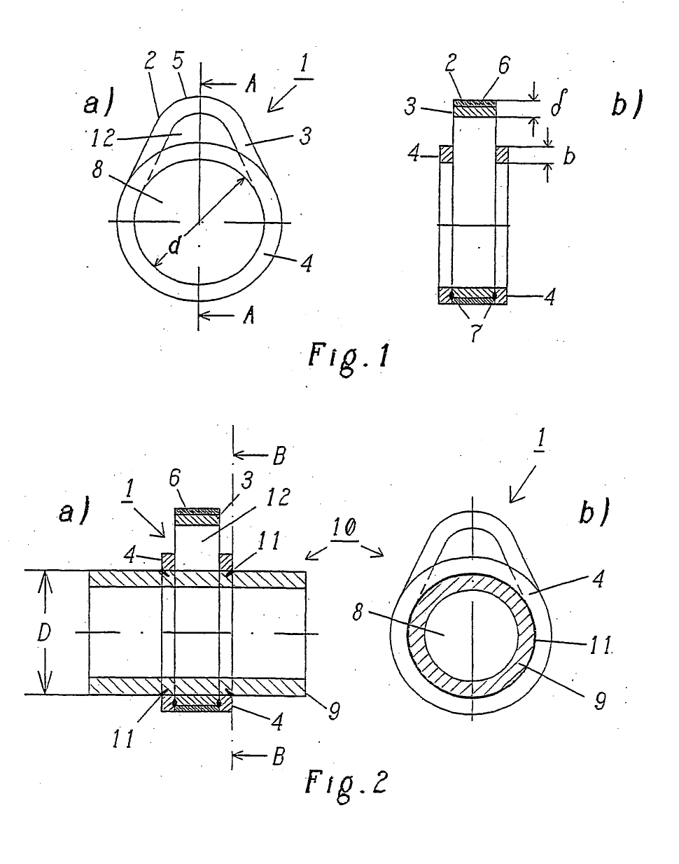

The cam 1 of FIG. 1 has a core 3 which comprises a rocker running surface 2 and consists of a high-carbon steel and which is arranged in the axial direction between two annular elements 4 consisting of a low-carbon steel. The core has, as seen on the circumference, an essentially uniform thickness δ corresponding to the width b of the annular elements 4. A cam elevation or cam tip 5 is formed by means of the core 3. The core 3 is hardened along the rocker running surface 2. The corresponding surface hardening zone is designated by 6.

Where they overlap one another, the core 3 and the two annular elements 4 are connected to one another by means of a resistance weld 7 executed by the parts being pressed against one another. By means of this type of connection technique, the two different steels can be welded to one another so as to be pore-free and crack-free.

FIG. 2 shows the cam 1 of FIG. 1 pushed with its passage orifice 8 into a shaft 9 consisting of a low-carbon steel and welded to the shaft 9 so as to form a camshaft 10, the weld 11 in each case being executed, in particular by laser welding, in a fully encircling manner over 360° along the seam between the two annular elements 4 and the shaft 9. Since both the shaft 9 and the two annular elements 4 consist of a low-carbon steel, they can be welded to one another so as to be pore-free and crack-free effectively and even at the ambient temperature of the parts.

The diameter d at the passage orifice 8 of the cam 1, said diameter being determined, inter alia, by the inside diameter of the annular elements 4, corresponds to the outside diameter D of the shaft 9, so that the cam 1 sits on the shaft 9 in an essentially gap-free manner. This also applies to the core 3, in so far as it does not project from the shaft 9 in the region of the cam tip 5 so as to form a cavity 12.

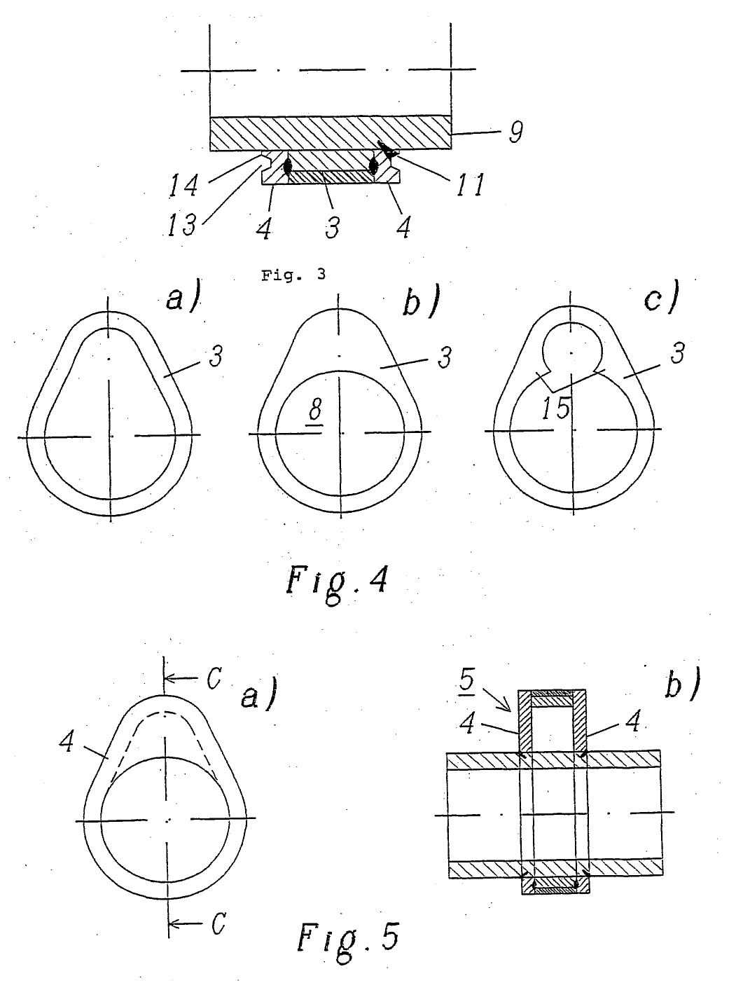

FIG. 3 shows, in a kind of enlargement of a detail from FIG. 2a), a particular embodiment of the two annular elements 4, their being provided in each case with an annular groove 13. The annular groove 13 gives rise to a kind of welding foot 14, through which the weld 11 is executed in the right-hand part of FIG. 3. The presence of the welding foot 14 results in an advantageously wide welding cross section between the annular elements 4 and the shaft 9, said welding cross section being highly stable and having high load-bearing capacity. In the left-hand part of FIG. 3, the weld 11 is omitted, so as to make the welding foot 14 more clearly visible. In the above-described embodiment of the cam 1 according to FIG. 1, the core 3 has a uniform thickness δ over the circumference, thus resulting, in the region of the cam tip 5, in a clearance or cavity 12 between the core 3 and the shaft 9. FIG. 4, under a), shows the core 3 once again in this design. This is, however, only one possibility which is particularly advantageous when, as described in more detail below, the core is produced from a profile strip by bending. The core 3 could, however, just as easily also have a greater thickness in the region of the cam tip, as shown in FIG. 4, for example under b), where the passage orifice 8 is circular-cylindrical and a cavity 12 is avoided in any case. This could also be called a solid-core cam here. It goes without saying that the embodiment of FIG. 4b) has higher bending resistance in the region of the cam tip 5, as compared with that of FIG. 4a). By contrast, however, the embodiment of FIG. 4a) is distinguished by a lower cam weight, by a lower material consumption, by a smaller imbalance during rotation and by simpler production. FIG. 4c,) shows a transitional form between the embodiments of FIG. 4a) and 4b). There, the core 3 is provided, in each case in the transitional region to a cavity 12, with thickenings 15 which fit snugly against the shaft surface and have some stiffening action for the cam tip 5. On the other hand, however, a comparable stiffening of the cam tip 5 is also brought about by the two annular elements 4, since these are, of course, in contact with the shaft in a fully encircling manner. If appropriate, this additional stiffening action through the annular elements 4 is itself sufficient to make it possible in practice, to execute the core 3 according to FIG. 4a.

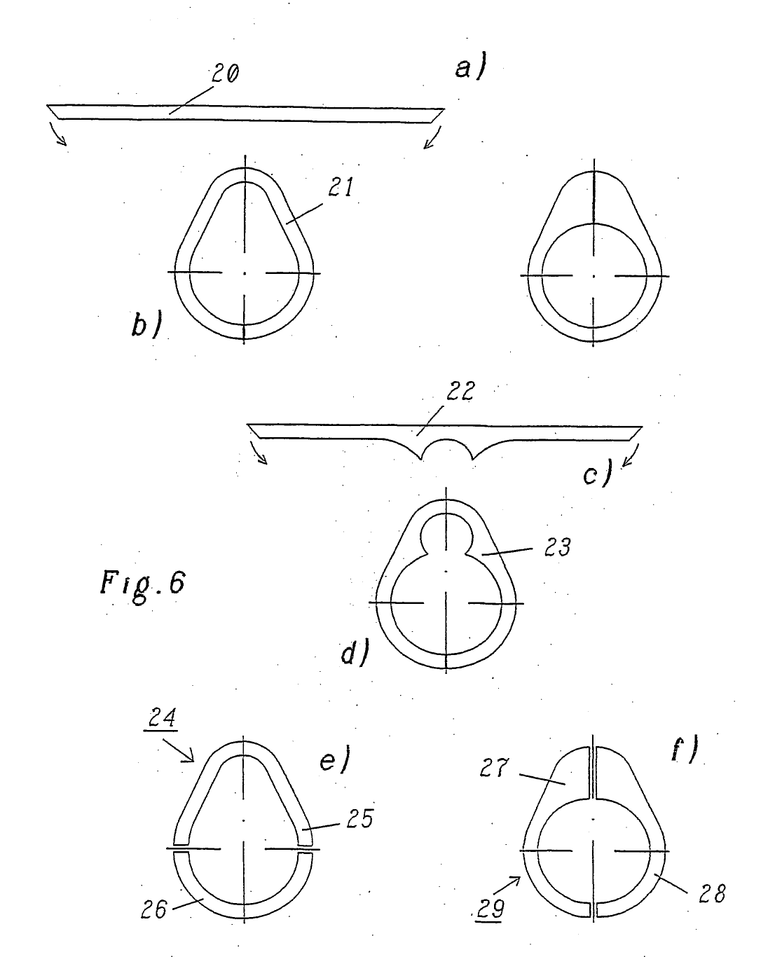

A measure further increasing the stiffness of the cam tip 5 could also involve designing the annular elements 4, in terms of their form, according to the cross-sectional form of the solid core of FIG. 4b), instead of annularly, and connecting them to a core 3 according to FIG. 4a) in a fully encircling manner, as shown in FIG. 5 under a) and b). The cam tip 5, too, would then be supported on the shaft via the two elements 4 formed in this way and capable of being produced readily by stamping and would additionally be stabilized per se against transverse forces.

As already mentioned, the core of the above-described cam 1 can be produced in a simple way by bending from one, but also from a plurality of profile strips which, for example, are cut to length from a longer strip. FIG. 6 shows, under a), a simple profile strip 20 and, under b), the core 21 for a cam 1, such as is obtained by the two ends of the profile strip 20 being bent together. Subsequently, the two ends can also be connected to one another and the core 21 is thereby closed. In particular, resistance pressure welding is again suitable for this purpose. A welding bead possibly occurring in this case would then also have to be removed subsequently.

FIG. 6 shows, under c), a profile strip 22 of nonuniform thickness, for which the cam core 23 illustrated under d) can be produced by the ends of the said profile strip being bent together and which corresponds to that of FIG. 4c).

FIG. 6 shows, under e), a cam core 24 which is composed of two profile strips bent in each case into half shells 25, 26. The two butting points of the two half shells 25, 26 may again be welded to one another. This embodiment has the advantage that the profile strips do not have to be bent to such an extent and the material is consequently exposed to fewer loads. FIG. 6 shows, under f), how, for example, a solid core 29 according to FIG. 4b) can also be produced from two half shells 27, 28.

In all the embodiments of FIG. 6, the butting points could also be arranged at another point along the cam circumference, in particular, in each case, offset at 180° or 90°, as may also be gathered from the comparison of FIGS. 6e) and 6f).

Since and in so far as the butting points of the cam cores according to FIG. 6, produced by bending, are bridged by the annular elements 4 being added on both sides and therefore a closing of the core takes place in any case as a result, a previous connection of the butting ends, as described above, may, if appropriate, even be dispensed with. In this case, however, it would be beneficial to cause the butting ends of the core to overlap one another somewhat in the circumferential direction (for example, an oblique cut). Conversely, it would be possible, instead of closed annular elements 4, to use only ring segments and, for example, to bridge the butting points of the latter by means of the core.

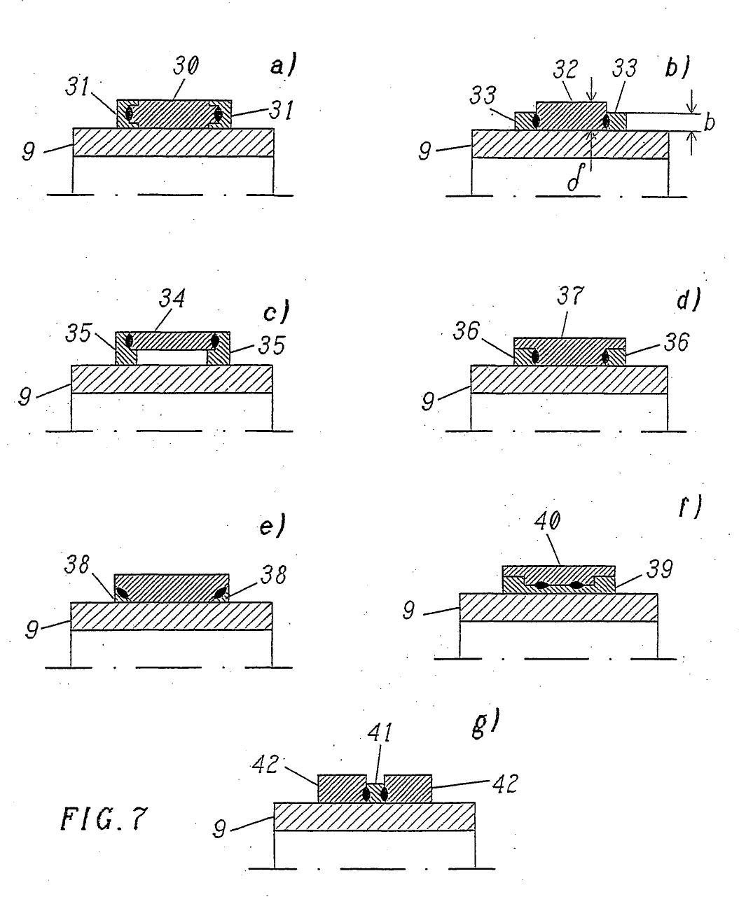

FIG. 7 shows, under a)-g), further embodiments of cams according to the invention.

In the variant of FIG. 7a), a core 30 consisting of a high-carbon steel is flanked by two annular elements 31 of c-shaped cross section, which are arranged on both sides of it and are connected to it by form fitting and, for example by resistance pressure welding and which consist of a low-carbon steel. In the variant of FIG. 7b), the width b of two annular elements 33 consisting of a low-carbon steel and arranged on both sides of a core 32 consisting of a high-carbon steel is selected smaller than the thickness δ of the core 32, so that the latter projects radially outward beyond the elements 33. In the variant of FIG. 7c), the ratios with regard to the widths b or the thickness δ are reversed. Here, too, the core 34 of the annular elements 35 overlap one another in each case in the axial direction. In the variant of FIG. 7d), annular elements 36 corresponding to FIG. 7b) are embedded into lateral grooves of a core 37 or the core 37 is drawn forward outwardly on both sides over the annular elements 36 as far as the end faces of the latter. The same applies accordingly to the variant of FIG. 7e), except that, here, the annular elements 38 have a triangular cross section. In the embodiment of FIG. 7f), there is only a single annular element 39 consisting of a low-carbon steel, which is arranged completely below a core 40 consisting of a high-carbon steel. The cam thereby acquires a two-shell construction. Finally, in the embodiment of FIG. 7g), the ratios are reversed in so far as, here, two annular elements 42 consisting of a high-carbon steel are arranged on both sides of a core 41 consisting of a low-carbon steel. Welding to the shaft of the camshaft would in this case have to be executed, for example, through the core 41.

In all the exemplary embodiments described above, other connection techniques, including soldering, plating, form fitting, nonpositively, form fitting and friction, adhesive bonding, riveting and/or friction-welding methods, could also be used, in addition to the resistance pressure welding mentioned, in order to connect the parts consisting of the high-carbon steel, on the one hand, and of the low-carbon steel, on the other hand.

1. A built-up camshaft with a plurality of cams fastened on a shaft in each case by means of at least one weld, the shaft consisting of a first low-carbon steel, and the cams having a hardened or hardenable rocker running surface consisting of a high-carbon steel, characterized in that the cams themselves are composed of at least two different materials, and a second low-carbon steel capable of being welded effectively to the steel of the shaft is used in each case in at least one region affected by the weld.

2. The camshaft as claimed in claim 1, characterized in that the different materials of the cams are connected to one another by soldering, plating, form fitting, nonpositively, by form fitting and friction, adhesive bonding, riveting and/or welding, in particular resistance pressure and/or friction welding.

3. The camshaft as claimed in claim 1, characterized in that the cams have a core which comprises the rocker running surface and consists of the high-carbon steel and which is arranged in the axial direction between at least two annular and/or ring-segment-shaped elements welded to the shaft and consisting of the second low-carbon steel.

4. The camshaft as claimed in claim 1, characterized in that the cams have an at least two-shell construction and have an outer shell comprising the rocker running surface and consisting of the high-carbon steel and at least one inner shell welded to the shaft and consisting of the second low-carbon steel.

5. The camshaft as claimed in claim 1, characterized in that the cams have a core which is welded to the shaft and consists of the second low-carbon steel and which is arranged in the axial direction between two annular elements comprising the rocker running surface and consisting of a high-carbon steel.

6. The camshaft as claimed in claim 1, characterized in that the part or parts of the cams consisting of the second low-carbon steel are welded to the shaft in a fully encircling manner.

7. The camshaft as claimed in claim 1, characterized in that those parts of the cams which form or comprise the rocker running surfaces are produced in each case from at least one bent profile strip, the profile strip or profile strips projecting in each case from the shaft preferably in the region of the cam tip.

8. The camshaft as claimed in claim 7, characterized in that mutually abutting ends of the profile strip or profile strips are welded to one another, in particular by resistance pressure welding.

9. The camshaft as claimed in claim 7, characterized in that mutually abutting ends of the profile strip or profile strips are connected to one another solely via that part or those parts of the cams which consist of the second low-carbon steel.

10. The camshaft as claimed in claim 1, characterized in that mutually abutting ends of the profile strip or profile strips are designed to overlap one another in the circumferential direction.

11. The camshaft as claimed in claim 1, characterized in that those parts of the cams which form or comprise the rocker running surfaces are in one piece and surround the shaft, flush, preferably over the entire circumference.

12. The camshaft as claimed in claim 1, characterized in that a foot ring is provided adjacently to the shaft in the part or parts consisting of the second low-carbon steel, in at least one of the regions affected by the weld, and the weld is executed through this foot ring.

13. The camshaft as claimed in claim 1, characterized in that the first low-carbon steel used for the shaft and/or the second low-carbon steel used for cams has a carbon content of lower than 0.5%.

14. The cam shaft as claimed in claim 1, characterized in that the high-carbon steel used for the rocker running surface of the cams has a carbon content of more than 0.5%, but, in particular of more than 0.75%.

15. A method for producing a camshaft as claimed in claim 1, characterized in that the cams, before assembly are hardened and additionally, if appropriate, annealed.

16. A method for producing a camshaft as claimed in claim 1, characterized in that welding for fastening the cams on the shaft is carried out at the ambient temperature of the parts to be welded to one another.

17. A method for producing a camshaft as claimed in claim 1, characterized in that the welding for fastening the cams on the shaft takes place by laser.

18. The camshaft as claimed in claim 15, for producing a camshaft as claimed in claim 1, characterized in that welding for fastening the cams on the shaft is executed at a welding speed of higher than 2 m/s, but, in particular of higher than 4 m/s.

19. A method for producing a camshaft as claimed in claim 1, characterized in that the cams, before being welded to the shaft, are prefixed on the shaft in that their elements to be welded to the shaft and consisting of the second low-carbon steel are calked together with the shaft.

20. A cam as defined in claim 1.
